(19) United States
(12) Patent Application Publication
(10) Pub. No.: US 2024/0420890 A1
(43) Pub. Date: Dec. 19, 2024

(54) MULTILAYER CERAMIC CAPACITOR

(71) Applicant: Murata Manufacturing Co., Ltd., Nagaokakyo-shi (JP)

(72) Inventor: Akitaka DOI, Nagaokakyo-shi (JP)

(21) Appl. No.: 18/814,857

(22) Filed: Aug. 26, 2024

Related U.S. Application Data
(63) Continuation of application No. PCT/JP2023/037367, filed on Oct. 16, 2023.

(30) Foreign Application Priority Data
Jan. 13, 2023 (JP) 2023-003824

(51) Int. Cl. H01G 4/008; H01G 4/012; H01G 4/12; H01G 4/30

(52) U.S. Cl. CPC H01G 4/0085; H01G 4/012; H01G 4/1227; H01G 4/30

(57) ABSTRACT

A multilayer ceramic capacitor includes dielectric layers including Ba and Ti, and internal electrode layers including Ni. A dimension L0 in a length direction, a dimension T0 in a lamination direction, and a dimension W0 in a width direction satisfy 1.7≤L0/T0≤2.3 and 1.0≤W0/T0≤1.4. Adjacent ends of the internal electrode layers have a positional deviation of about 5 μm or less in the width direction. Segregation of Sn with an atomic composition percentage of about 2 at % or higher occurs at an interface between the internal electrode layer and the dielectric layer. A dimension of each side gap portion in the width direction is WS, a dimension of each outer layer portion in the lamination direction is TG, and 0.3≤WS/TG≤0.6. For each internal electrode layer, a dimension in the width direction is WI, and T0<WI.

### CROSS REFERENCE TO RELATED APPLICATIONS

This application is a Continuation Application of PCT Application No. PCT/JP2023/037367 filed on Oct. 16, 2023 and claims the benefit of priority Japanese Application No. 2023-003824 filed on Jan. 13, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

There is a known technique for decreasing a withstand voltage failure and supporting an increase in capacitance of a multilayer ceramic capacitor (see Japanese Unexamined Patent Application, Publication No. 2005-259772). According to the known technique, an attempt to achieve both a decrease in withstand voltage failure and an increase in capacitance is made by adjusting the radius of curvature of the corners of internal electrode layers and the radius of curvature of the ridges of a multilayer body.

### SUMMARY OF THE INVENTION

However, the multilayer ceramic capacitor according to the known art described above requires adjustment of the shape of the internal electrode layers and the shape of the ridges of the multilayer body, and consequently, the manufacturing becomes complicated.

Recent mobile devices are further miniaturized and have further enhanced performance, which generates an increasing demand for multilayer ceramic capacitors that are small in size and large in capacitance. In view of the foregoing circumstances, example embodiments of the present invention provide multilayer ceramic capacitors each capable of ensuring sufficient reliability in a device having dimensional constraints, while achieving balance between capacitance and breakdown voltage.

An example embodiment of the present invention provides a multilayer ceramic capacitor including a multilayer body, and external electrodes, the multilayer body including a multilayer chip including an inner layer portion in which dielectric layers and internal electrode layers are alternately laminated on each other, and outer layer portions respectively provided on both sides of the inner layer portion in a lamination direction, and side gap portions respectively provided on both sides of the multilayer chip in a width direction that intersects with the lamination direction, the external electrodes being respectively provided ends of the multilayer body in a length direction that intersects with the lamination direction and the width direction, in which, each of the dielectric layers includes Ba and Ti, and each of the internal electrode layers includes Ni, a dimension of the multilayer body in the length direction is defined as a dimension L0, a dimension of the multilayer body in the lamination direction is defined as a dimension T0, a dimension of the multilayer body in the width direction is defined as a dimension W0, and 1.7≤L0/T0≤2.3 and 1.0≤W0/T0≤1.4 are satisfied, in a cross section taken at a center in the length direction and extending in the lamination direction and the width direction, ends in the width direction of the internal electrode layers that are adjacent to each other in the lamination direction have a positional deviation d in the width direction, and the positional deviation d is about 5 μm or less, segregation of Sn with an atomic composition percentage of about 2 at % or higher occurs at an interface between each internal electrode layer and the dielectric layer adjacent to the internal electrode layer, a dimension of each of the side gap portions in the width direction is defined as a dimension WS, a dimension of each of the outer layer portions in the lamination direction is defined as a dimension TG, and 0.3≤WS/TG≤0.6 is satisfied, and for each of the internal electrode layers, a dimension in the width direction is defined as a dimension WI, and T0<WI is satisfied.

Multilayer ceramic capacitors according to the example embodiments of the present invention are capable of ensuring sufficient reliability under dimensional constraints, while achieving balance between capacitance and breakdown voltage.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view of the multilayer ceramic capacitor 1, taken along line II-II in FIG. 1.

FIG. 3 is a cross-sectional view of the multilayer ceramic capacitor 1, taken along line III-III in FIG. 1.

FIG. 4 illustrates, on an enlarged scale, a portion denoted by S in FIG. 3.

FIG. 5 is a flowchart illustrating a method of manufacturing the multilayer ceramic capacitor 1.

### DETAILED DESCRIPTION OF THE EXAMPLE EMBODIMENTS

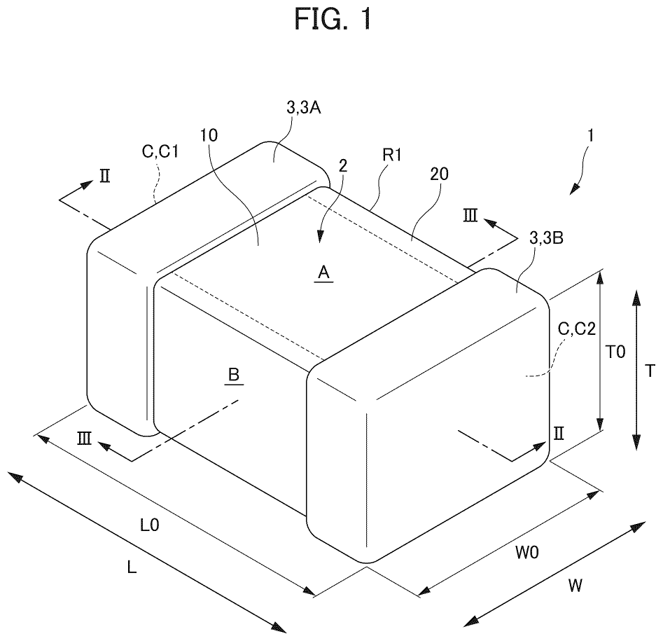

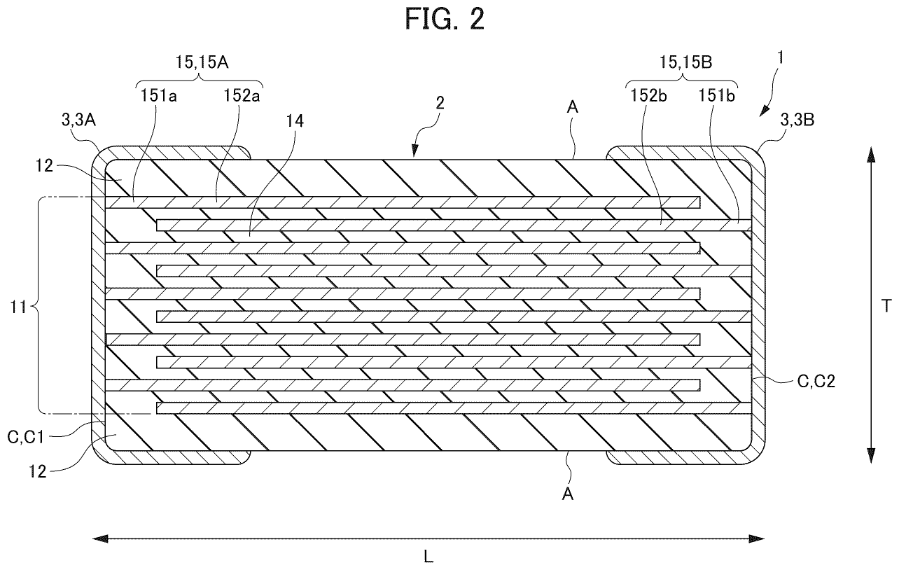

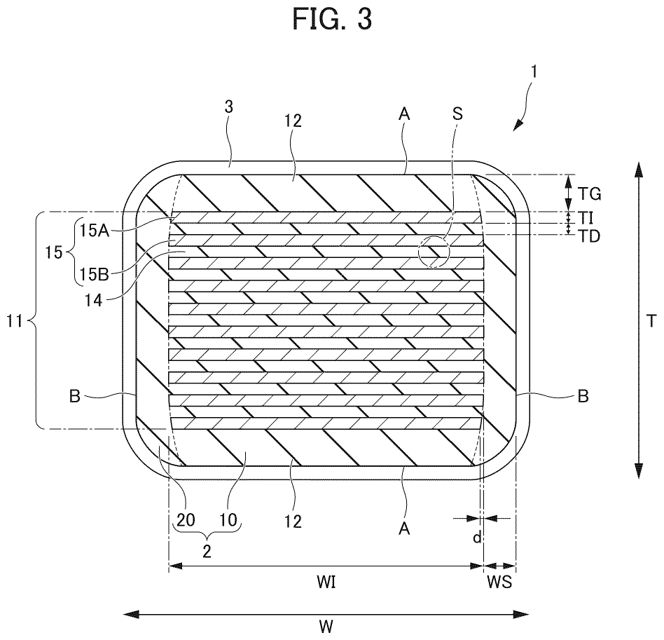

A multilayer ceramic capacitor 1 according to an example embodiment of the present invention will be described below. FIG. 1 is a schematic perspective view of the multilayer ceramic capacitor 1 according to the present example embodiment. FIG. 2 is a cross-sectional view of the multilayer ceramic capacitor 1, taken along line II-II in FIG. 1. FIG. 3 is a cross-sectional view of the multilayer ceramic capacitor 1, taken along line III-III in FIG. 1.

### Multilayer Ceramic Capacitor 1

The multilayer ceramic capacitor 1 has a substantially rectangular parallelepiped shape and includes a multilayer body 2 and a pair of external electrodes 3 respectively provided at both ends of the multilayer body 2. The multilayer body 2 includes an inner layer portion 11 in which a plurality of dielectric layers 14 and a plurality of internal electrode layers 15 are laminated.

In the following description, the orientation of the multilayer ceramic capacitor 1 is described using the following terms. A direction in which the pair of external electrodes 3 on the multilayer ceramic capacitor 1 are arranged is defined as a length direction L. A direction in which the dielectric layers 14 and the internal electrode layers 15 are laminated is defined as a lamination direction T. A direction intersecting with both the length direction L and the lamination direction T is defined as a width direction W. In the present example embodiment, the width direction W is orthogonal to both the length direction L and the lamination direction T.

In the following description, from among the six outer surfaces of the multilayer body 2 illustrated in FIG. 1, a pair of outer surfaces opposite to each other in the lamination direction T are referred to as main surfaces A, a pair of outer surfaces opposite to each other in the width direction W are referred to as side surfaces B, and a pair of outer surfaces opposite to each other in the length direction L are referred to as a first end surface C1 and a second end surface C2. The first end surface C1 and the second end surface C2 are collectively referred to as an end surface (s) C when it is unnecessary to particularly distinguish from each other.

For the multilayer ceramic capacitor 1, a dimension in the length direction L is defined as a dimension L0, a dimension in the lamination direction T is defined as a dimension T0, and a dimension in the width direction W is defined as a dimension W0. The dimension L0 is preferably about 1.15 μm or greater and about 1.25 μm or less, and more preferably about 1.220 μm, for example. The dimension W0 is preferably about 0.65 μm or greater and about 0.75 μm or less, and more preferably about 0.725 μm, for example. The dimension T0 is preferably about 0.55 μm or greater and about 0.65 μm or less, and more preferably about 0.620 μm, for example. This configuration makes it possible to provide the multilayer ceramic capacitor 1 having dimensions in the height and width directions that allow for mounting thereof in a device having constraints on the height and width directions and to ensure the multilayer ceramic capacitor 1 a capacitance.

Furthermore, it is preferable that the following relationships are satisfied: 1.7≤L0/T0≤2.3; and 1.0≤W0/T0≤1.4, for example. This configuration makes it possible to provide the multilayer ceramic capacitor 1 having dimensions in the height and width directions that allow for mounting thereof in a device having constraints on the height and width directions and to ensure the multilayer ceramic capacitor 1 a capacitance.

It is preferable that a ratio between L0, TO, and W0 is about 2:1:1.2 (L0:TO:W0≈2:1:1.2). This configuration makes it possible to provide the multilayer ceramic capacitor 1 having dimensions in the height and width directions that allow for mounting thereof in a device having constraints on dimensions in the height and width directions and ensure the multilayer ceramic capacitor 1 a capacitance.

### Multilayer Body 2

The multilayer body 2 includes a multilayer chip 10 and side gap portions 20.

### Multilayer Chip 10

The multilayer chip 10 includes the inner layer portion 11 and outer layer portions 12 provided on both sides of the inner layer portion 11 that are adjacent to the main surfaces A.

### Inner Layer Portion 11

The inner layer portion 11 includes the plurality of dielectric layers 14 and the plurality of internal electrode layers 15 that are laminated. The dielectric layers 14 and the internal electrode layers 15 will be described in detail later.

### Outer Layer Portion 12

The outer layer portions 12 include the same dielectric ceramic material as that of the dielectric layers 14 included in the inner layer portion 11. Each outer layer portion 12 has a dimension TG in the lamination direction T, which is preferably about 36 μm or greater and about 43 μm or less, and more preferably about 40 μm, for example. Designing each outer layer portion 12 to have the dimension TG within the foregoing range makes it possible to provide the multilayer ceramic capacitor 1 dimensioned to be mountable in a device having dimensional constraints and to ensure the multilayer ceramic capacitor 1 has a required capacitance.

### Side Gap Portion 20

The side gap portions 20 are provided on sides of the multilayer chip 10 that are adjacent to the side surfaces B. The side gap portions 20 extend along and cover ends in the width direction W of the internal electrode layers 15, which are exposed at both side surfaces of the multilayer chip 10. The side gap portions 20 include the same dielectric ceramic material as that of the dielectric layers 14.

### Dimensions of Side Gap Portion 20

For each side gap portion 20, a dimension in the width direction W is defined as a dimension WS, which is preferably about 15 μm or greater and about 20 μm or less, and more preferably about 17 μm, for example. A ratio of the dimension WS of the side gap portion 20 in the width direction W to the dimension TG of the outer layer portion 12 in the lamination direction T preferably satisfies 0.3≤WS/TG≤0.6, and more preferably 0.4≤WS/TG≤0.5, for example. Setting the dimensional ratio within the forgoing ranges makes it possible to provide the multilayer ceramic capacitor 1 dimensioned to be mountable in a device having dimensional constraints and to ensure that the multilayer ceramic capacitor 1 has a required capacitance.

### External Electrode 3

The external electrodes 3 include a first external electrode 3A provided on the first end surface C1 of the multilayer body 2 and a second external electrode 3B provided on the second end surface C2 of the multilayer body 2. The first external electrode 3A and the second external electrode 3B are collectively referred to as the external electrode(s) 3 when it is unnecessary to particularly distinguish from each other. The external electrode 3 covers not only the end surface C but also portions of the main surfaces A and portions of the side surfaces B that are adjacent to the end surface C.

### Dielectric Layer 14

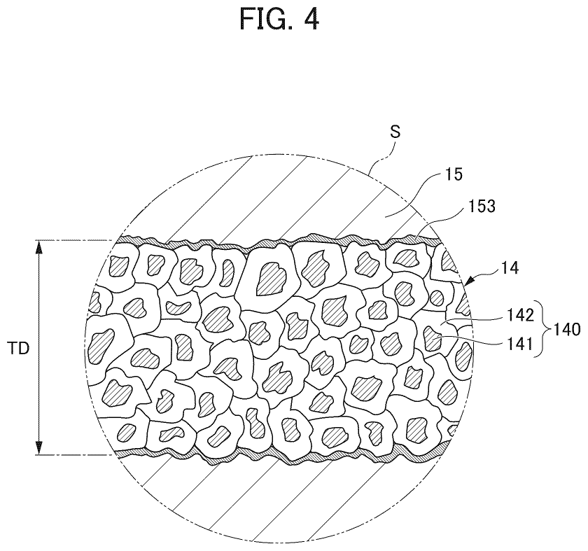

FIG. 4 illustrates, on an enlarged scale, the portion denoted by S in FIG. 3. The dielectric layers 14 include, as a base material, BaTiO₃ including Ba and Ti. In the structure of BaTiO₃, a first element M1 that is a rare-earth element examples of which include Nd, Sm, Eu, Gd, Tb, Dy, Ho, Er, Tm, Yb, etc., a second element M2 that is Ni dispersing from the internal electrode layers 15, and an optionally added element are solid-solved. The BaTiO₃ including Ba and Ti and used as the base material is a ferroelectric material having a very high permittivity, and therefore, allows for ensuring that the multilayer ceramic capacitor 1 has a large capacitance.

M1³⁺ of the first element M1 substitutes for a portion of Ba²⁺ in the crystal lattice of the BaTiO₃-based perovskite-type compound, whereby the first element M1 is solid-solved in a grain 140. Ni²⁺ of Ni substitutes for a portion of Ti⁴⁺ in the crystal lattice of the BaTiO₃-based perovskite-type compound, whereby Ni is solid-solved in the grain 140.

Each dielectric layer 14 includes a plurality of the grains 140. Each grain 140 has a core-shell structure including a core 141 located in a central portion of the grain 140 and a shell 142 surrounding the core 141. The core 141 includes the solid-solved elements described above in a smaller amount than the shell 142, and is closer to pure BaTiO₃. A molar ratio of Ba in the core 141 to Ti included in the grain 140 is higher than a molar ratio of Ba in the shell 142 to Ti included in the grain 140. This feature in which the molar ratio of Ba in the core 141 to Ti included in the grain 140 is higher than the molar ratio of Ba in the shell 142 to Ti included in the grain 140 improves insulation resistance.

The shell 142 includes the first element M1 in a larger amount than the core 141. Therefore, due to the substitution of M1³⁺ for Ba²⁺, Ba vacancies are formed in the vicinity of a grain boundary. As a result, oxygen vacancies are captured by the Ba vacancies within each dielectric layer 14, whereby movement of the oxygen vacancies in the dielectric layer 14 that is caused by application of a DC voltage is reduced or prevented.

Thus, the reliability of the multilayer ceramic capacitor 1 including the dielectric layers 14 including BaTiO₃ is improved.

However, the grain 140 is not limited to the core-shell structure, and may include the first and second elements uniformly distributed therein.

### Number of Grains in Dielectric Layer 14

For example, non-limiting example specifications of the multilayer ceramic capacitor 1 of the present example embodiment are as follows.
Rated voltage: 6.3 V
Initial capacitance: 15 μF
Effective capacitance: 5 μF at a DC of 3 V
Breakdown voltage: 60 V

With the example specifications, each dielectric layer 14 has a thickness (dimension in the lamination direction T) TD of preferably about 0.67 μm or greater and about 0.73 μm or less, and more preferably about 0.70 μm, for example. The number of the dielectric layers 14 is preferably 405 or more and 430 or less, for example. The grains 140 preferably have a grain diameter of about 150 nm or greater and about 200 nm or less, for example. An average value GN of the numbers of grains 140 arranged in the thickness direction (lamination direction T) in the dielectric layers 14 is preferably 3 or more and 4 or less, for example.

With the feature in which the thickness (dimension in the lamination direction T) TD of each dielectric layer 14 is about 0.67 μm or greater and about 0.73 μm or less, for example, the multilayer ceramic capacitor 1 is dimensioned to be mountable in a device having a constraint on the total height of the multilayer ceramic capacitor. The feature in which the average value GN of the numbers of grains 140 arranged in the thickness direction (lamination direction T) in the dielectric layers 14 is 3 or more and 4 or less makes it possible to reduce or prevent a decrease in the insulation resistance of the dielectric layers 14, while providing the multilayer ceramic capacitor 1 dimensioned to be mountable in a device having dimensional constraints.

Another non-limiting example of specifications of the multilayer ceramic capacitor 1 of the present example embodiment is as follows.
Required characteristics: 10 V
Initial capacitance: 10 μF
Effective capacitance: 4 μF at a DC of 3 V
Breakdown voltage: 80 V

With the example specifications, each dielectric layer 14 has a thickness (dimension in the lamination direction T) TD of preferably about 0.85 μm or greater and about 0.91 μm or less, and more preferably about 0.88 μm, for example. The number of the dielectric layers 14 is preferably 350 or more and 375 or less, for example. The grains 140 preferably have a grain diameter of about 150 nm or greater and about 200 nm or less, for example. An average value GN of the numbers of grains 140 arranged in the thickness direction (lamination direction T) in the dielectric layers 14 is preferably 4 or more and 5 or less, for example.

With the feature in which the thickness (dimension in the lamination direction T) TD of each dielectric layer 14 is about 0.85 μm or greater and about 0.91 μm or less, for example, the multilayer ceramic capacitor 1 is dimensioned to be mountable in a device having a constraint on the total height of the multilayer ceramic capacitor. The feature in which the average value GN of the numbers of grains 140 arranged in the thickness direction (lamination direction T) in the dielectric layers 14 is 4 or more and 5 or less makes it possible to reduce or prevent a decrease in the insulation resistance of the dielectric layers 14, while making the multilayer ceramic capacitor 1 conform to constraints on the dimension in the height direction.

As will be described later, the internal electrode layers 15 are adjacent to each other with counter portions 152 thereof opposed to each other, and the counter portions 152 are effective portions that function as a capacitor.

It is preferable that the grain diameter of the grains in the dielectric layers 14 disposed between the effective portions is larger than the grain diameter of the grains in the dielectric forming the side gap portions 20.

The permittivity of the dielectric increases with increase in the grain diameter. The moisture resistance and durability of the dielectric increase with decrease in the grain diameter. Since the grain diameter of the grains in the dielectric layers 14 disposed between the effective portions is larger than the grain diameter of the grains in the dielectric forming the side gap portions 20, the permittivity between the effective portions can be maintained high, thereby making it possible to ensure a sufficient capacitance.

Furthermore, since the side gap portions 20 have high moisture resistance, the multilayer ceramic capacitor 1 in its entirety can have high moisture resistance and high durability.

### Internal Electrode Layer 15

For each internal electrode layer 15, a dimension in the width direction W is defined as a dimension WI, which is larger than the dimension T0 (T0<WI). Each internal electrode layer 15 has a dimension (thickness) TI in the lamination direction T, which is preferably about 0.49 μm or greater and about 0.55 μm or less, and more preferably about 0.53 μm, for example.

The feature in which the dimension WI in the width direction W of each internal electrode layer 15 satisfies T0<WI makes it possible to ensure that each internal electrode layer has a large area, while reliably making the multilayer ceramic capacitor 1 have a height that allows for mounting in a device having dimensional constraints. Thus, it is possible to ensure that the multilayer ceramic capacitor 1 has a large capacitance.

The internal electrode layers 15 include a metal material, but are not fully filled with the metal material.

Each internal electrode layer 15 includes voids where the metal material is absent. A ratio of a portion occupied by the metal material in each internal electrode layer 15 is defined as a coverage, and the coverage is preferably about 85% or more, for example.

The internal electrode layers 15 include a plurality of first internal electrode layers 15A and a plurality of second internal electrode layers 15B. The first internal electrode layers 15A and the second internal electrode layers 15B are alternately arranged with each other. The first internal electrode layer 15A and the second internal electrode layer 15B are collectively referred to as the internal electrode layer(s) 15 when it is unnecessary to particularly distinguish from each other.

Each first internal electrode layer 15A includes a first counter portion 152a that is opposed to the second internal electrode layer 15B, and a first lead-out portion 151a extending from the first counter portion 152a to be led out to the first end surface C1. An end of the first lead-out portion 151a is exposed at the first end surface C1, and is electrically connected to the first external electrode 3A, which will be described later.

Each second internal electrode layer 15B includes a second counter portion 152b that is opposed to the first internal electrode layer 15A, and a second lead-out portion 151b extending from the second counter portion 152b to be led out to the second end surface C2. An end of the second lead-out portion 151b is exposed at the second end surface C2, and is electrically connected to the second external electrode 3B, which will be described later.

According to the internal electrode layers 15 described above, electric charge is accumulated in the first counter portions 152a of the first internal electrode layers 15A and the second counter portions 152b of the second internal electrode layers 15B, which allows for fulfillment of the function of capacitor. The counter portions 152 at which the adjacent internal electrode layers 15 are opposite to each other define the effective portions that fulfill the function of capacitor.

### Deviation d

As will be described later, the multilayer chip 10 is produced by cutting a mother block, and therefore, has flat side surfaces where the ends of the internal electrode layers 15 are exposed. The side gap portions 20 are formed on the both side surfaces of the multilayer chip 10 by a so-called technique for post-forming side gap portions.

Accordingly, as illustrated in FIG. 3, in a WT cross section taken at a center of the multilayer body 2 and extending in the width direction W and the lamination direction T, the ends in the width direction W of two internal electrode layers 15 (first and second internal electrode layers 15A and 15B) vertically adjacent to each other in the lamination direction T have a positional deviation d as small as about 5 μm or less (d≤5 μm) in the width direction W, for example.

In other words, the ends in the width direction W of the first internal electrode layer 15A and the second internal electrode layer 15B that are vertically adjacent to each other in the lamination direction T are at substantially the same position in the width direction W and are substantially aligned with each other in the lamination direction T.

The feature in which d≤5 μm is satisfied enables each internal electrode layer 15 to have as large an area as possible under dimensional constraints, thereby making it possible to ensure that the multilayer ceramic capacitor 1 has a large capacitance.

The internal electrode layers 15, a main component of which is Ni, include Sn. Each internal electrode layer 15 has interface-neighboring regions 153 that are each, for example, about 20 nm thick from its surfaces opposed to the dielectric layers 14, and segregation of Sn having an atomic composition percentage of 2 at % (atomic percent) or higher takes place in the interface-neighboring regions 153, for example. That is, the interface-neighboring regions 153 illustrated in FIG. 4 include Sn in a larger amount than the other portion of the internal electrode layer 15.

Each internal electrode layer 15 is formed by firing an internal-electrode-forming conductive paste including Ni powder, Ni—Sn alloy powder, and a Sn-component-including co-material. During a firing step, the Sn-component-including co-material is attracted toward the dielectric layers 14 for which the co-material has a high affinity, and the Sn component included in the co-material is also attracted toward the dielectric layers 14.

As a result, it becomes more probable for Sn to be present in each interface-neighboring region 153 close to the interface with the dielectric layer 14 than in the interior of the internal electrode layer 15. This causes the internal electrode layers 15 to be Ni—Sn alloyed, and a state of the interface-neighboring regions 153 changes. Specifically, a change in a state (height of an electric barrier) of the interface between the dielectric layer 14 and the internal electrode layer 15, which is caused by the formation of the alloy by Ni and Sn (Ni—Sn alloy), is considered to contribute to improvement of high-temperature load life. In particular, the presence of a large amount of the Ni—Sn alloy in the interface-neighboring regions 153 is presumed to play a key role in improving the high-temperature load life. Thus, the multilayer ceramic capacitor 1 can be produced which is improved in high-temperature load life and is highly reliable.

### Method of Manufacturing Multilayer Ceramic Capacitor 1

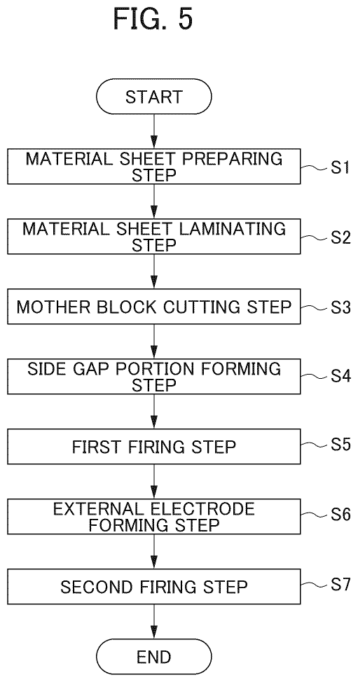

FIG. 5 is a flowchart illustrating a non-limiting example of a method of manufacturing the multilayer ceramic capacitor 1.

The example method of manufacturing the multilayer ceramic capacitor 1 includes a material sheet preparing step S1, a material sheet laminating step S2, a mother block cutting step S3, a side gap portion forming step S4, a first firing step S5, an external electrode forming step S6, and a second firing step S7.

### Material Sheet Preparing Step S1

Barium titanate-based perovskite-type compound powder including Ti and Ba is mixed with powder including the first element M1 and other additive elements, thereby producing a raw material powder. A ceramic slurry is then prepared which includes the raw material powder, a binder, and a solvent.

The ceramic slurry is formed into a sheet shape on a carrier film by using a die coater, a gravure coater, a micro-gravure coater, or the like to produce ceramic green sheets for the inner layer portion 11 and ceramic green sheets for the outer layer portion 12.

An internal-electrode-forming conductive paste including Ni powder, Ni—Sn alloy powder, and a Sn-component-including co-material is printed into a strip-shaped pattern on each ceramic green sheet for the inner layer portion 11, by way of screen printing, inkjet printing, gravure printing, or the like. As a result, material sheets are prepared. Each material sheet is composed of the ceramic green sheet for the inner layer portion 11, which is to form the dielectric layer 14 and on which the conductive paste to form the internal electrode layer 15 is printed.

### Material Sheet Laminating Step S2

Next, a plurality of the material sheets are laminated on each other. Specifically, the material sheets are laminated such that the strip-shaped patterns of the conductive paste are oriented in the same direction and are shifted by a half pitch in the width direction W between the adjacent material sheets.

Furthermore, the ceramic green sheets for the outer layer portion 12 are stacked on both sides of the resultant laminate of the material sheets. The laminate of the material sheets and the ceramic green sheets for the outer layer portion 12 are thermocompression-bonded to each other. As a result, a mother block is produced.

### Mother Block Cutting Step S3

The mother block is cut into pieces having a size corresponding to the dimensions of the multilayer chip 10.

### Side Gap Portion Forming Step S4

Next, ceramic green sheets for side gap portions are bonded to both side surface of the multilayer chip 10, thereby forming layers to form the side gap portions 20.

Here, since the multilayer chip 10 is produced by cutting the mother block, it has flat side surfaces where the ends of the internal electrode layers 15 are exposed. The side gap portions 20 are provided on the side surfaces of the multilayer chip 10 by a so-called technique for post-forming side gap portions.

### First Firing Step S5

The resultant semi-product, i.e., the multilayer chip 10 having thereon the layers to form the side gap portions 20, is subjected to a degreasing treatment under a predetermined condition in a nitrogen atmosphere. Thereafter, the semi-product is fired at a predetermined temperature in a nitrogen-hydrogen-water vapor atmosphere, thereby producing the multilayer body 2.

The internal electrode layers 15 are formed by firing the internal-electrode-forming conductive paste including the Ni powder, the Ni—Sn alloy powder, and the Sn-component-including co-material. During this first firing step, the Sn-component-including co-material is attracted toward the dielectric layers 14 for which the co-material has a high affinity, and the Sn component included in the co-material is also attracted toward the dielectric layers 14.

### External Electrode Forming Step S6

Subsequently, a conductive paste for forming the external electrodes 3 is applied to the end surfaces C of the multilayer body 2.

### Second Firing Step S7

Next, the multilayer body 2 is heated at a preset firing temperature for a predetermined time in a nitrogen atmosphere.

As a result, the external electrodes 3 are fired onto the multilayer body 2, thereby the multilayer ceramic capacitor 1 is manufactured. It is possible to perform the second firing step to fire the multilayer body 2 concurrently with the external electrodes 3, while omitting the first firing step.

The multilayer ceramic capacitor 1 of the example embodiment described above includes the multilayer body 2 and the external electrodes 3, the multilayer body 2 including the multilayer chip 10 that includes the inner layer portion 11 in which the dielectric layers 14 and the internal electrode layers 15 are alternately laminated on each other, and includes the outer layer portions 12 respectively provided on both sides of the inner layer portion 11 in the lamination direction T, and the side gap portions 20 respectively provided on both sides of the multilayer chip 10 in the width direction W that intersects with the lamination direction T, the external electrodes 3 being respectively provided at ends of the multilayer body 2 in the length direction L that intersects with the lamination direction T and the width direction W.

Each dielectric layer 14 includes Ba and Ti, and each internal electrode layer 15 includes Ni.

For the multilayer ceramic capacitor 1, a dimension in the length direction L is defined as the dimension L0, a dimension in the lamination direction T is defined as the dimension T0, a dimension in the width direction W is defined as the dimension W0, and 1.7≤L0/T0≤2.3 and 1.0≤W0/T0≤1.4 are satisfied, for example.

In a cross section taken at a center in the length direction L and extending in the lamination direction T and the width direction W, ends in the width direction W of the internal electrode layers 15 adjacent to each other in the lamination direction T have a positional deviation d in the width direction W, and the positional deviation d is about 5 μm or less, for example.

Segregation of Sn having an atomic composition percentage of about 2 at % or higher, for example, takes place at an interface between each internal electrode layer 15 and the dielectric layer 14 adjacent to the internal electrode layer 15.

A dimension of each side gap portion 20 in the width direction W is defined as the dimension WS, a dimension of each outer layer portion 12 in the lamination direction T is defined as the dimension TG, and 0.3≤WS/TG≤0.6 is satisfied, for example.

For each internal electrode layer 15, a dimension in the width direction W is defined as the dimension WI, and T0<WI is satisfied.

### Advantageous Effects

As described above, segregation of Sn having an atomic composition percentage of about 2 at % or higher, for example, takes place at the interface between the internal electrode layer 15 and the dielectric layer 14. Due to the segregation of Sn changes, each internal electrode layer 15 is Ni—Sn alloyed, and the state of the interface between the internal electrode layer 15 and the dielectric layer 14 changes. Thus, the change in the state (height of an electric barrier) of the interface between the dielectric layer 14 and the internal electrode layer 15, which is caused by the formation of the alloy by Ni and Sn (Ni—Sn alloy), makes it possible to produce the multilayer ceramic capacitor 1 that is improved in high-temperature load life and reliability.

In the cross section taken at a center in the length direction L and extending in the lamination direction T and the width direction W, the ends in the width direction W of the internal electrode layers 15 adjacent to each other in the lamination direction T have a positional deviation d in the width direction W, and the positional deviation d is about 5 μm or less, for example. Due to this feature, the dimension WS of each side gap portion 20 in the width direction W can be made thin so that 0.3≤WS/TG≤0.6 is satisfied, for example, where TG is the dimension TG of each outer layer portion 12 in the lamination direction T.

Thus, in the multilayer ceramic capacitor 1 having such a size that the dimension L0 in the length direction L, the dimension T0 in the lamination direction T, and the dimension W0 in the width direction W satisfy 1.7≤L0/T0≤2.3 and 1.0≤W0/T0≤1.4, each internal electrode layer 15 is made to have, in the width direction W, the dimension WI that is large enough to satisfy T0<WI, for example. As a result, each internal electrode layer 15 has a large area.

In the case where a dimension of each dielectric layer 14 in the lamination direction T is defined as the dimension TD, which is about 0.67 μm or greater and about 0.73 μm or less, the average value GN of the numbers of grains arranged in the lamination direction T in the dielectric layers 14 is 3 or more and 4 or less, for example. This feature, in which the average value GN of the numbers of grains is relatively large, leads to a larger number of grain boundaries in the dielectric layers 14 in comparison with a case where the number of grains is 1, resulting in an increase in the value of insulation resistance and an improvement in the durability.

In the case where a dimension of each dielectric layer 14 in the lamination direction T is defined as the dimension TD, which is about 0.85 μm or greater and about 0.91 μm or less, the average value GN of the numbers of grains arranged in the lamination direction T in the dielectric layers 14 is 4 or more and 5 or less, for example. This feature, in which the average value GN of the numbers of grains is relatively large, leads to a larger number of grain boundaries in the dielectric layers 14 in comparison with a case where the number of grains is 1, thereby increasing the value of insulation resistance and improving the durability.

For the multilayer ceramic capacitor 1, the dimension L0 in the length direction L is about 1.15 μm or greater and about 1.25 μm or less, the dimension W0 in the width direction W is about 0.65 μm or greater and about 0.75 μm or less, and the dimension T0 in the lamination direction T is about 0.55 μm or greater and about 0.65 μm or less, for example. The dimension WS of each side gap portion 20 in the width direction is about 15 μm or greater and about 20 μm or less, and the dimension TG of each outer layer portion 12 in the lamination direction T is about 36 μm or greater and about 43 μm or less, for example. The multilayer ceramic capacitor 1 of the size described above has high versatility and achieves balance between capacitance and breakdown voltage in a device having dimensional constraints.

The dielectric layers 14 each include a plurality of the grains 140, each grain 140 has a core-shell structure including the core 141 and the shell 142 surrounding the core 141, and a molar ratio of Ba in the core 141 to Ti included in the grain 140 is higher than a molar ratio of Ba in the shell 142 to Ti included in the grain 140. This feature makes it possible to smooth the temperature characteristics of the permittivity and improve the reliability.

As described above, the multilayer ceramic capacitor 1 according to the present example embodiment is capable of ensuring sufficient reliability while achieving balance between the initial capacitance, the effective capacitance, and the breakdown voltage under dimensional constraints.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body; and
external electrodes;
the multilayer body including a multilayer chip including an inner layer portion in which dielectric layers and internal electrode layers are alternately laminated on each other, and outer layer portions respectively provided on both sides of the inner layer portion in a lamination direction, and side gap portions respectively provided on both sides of the multilayer chip in a width direction that intersects with the lamination direction;
the external electrodes being respectively provided ends of the multilayer body in a length direction that intersects with the lamination direction and the width direction; wherein
each of the dielectric layers includes Ba and Ti, and each of the internal electrode layers includes Ni;
a dimension of the multilayer body in the length direction is defined as a dimension L0, a dimension of the multilayer body in the lamination direction is defined as a dimension T0, a dimension of the multilayer body in the width direction is defined as a dimension W0, and 1.7≤L0/T0≤2.3 and 1.0≤W0/T0≤1.4 are satisfied;
in a cross section taken at a center in the length direction and extending in the lamination direction and the width direction, ends in the width direction of the internal electrode layers that are adjacent to each other in the lamination direction have a positional deviation d in the width direction, and the positional deviation d is about 5 μm or less;
segregation of Sn with an atomic composition percentage of about 2 at % or higher occurs at an interface between each internal electrode layer and the dielectric layer adjacent to the internal electrode layer;
a dimension of each of the side gap portions in the width direction is defined as a dimension WS, a dimension of each of the outer layer portions in the lamination direction is defined as a dimension TG, and 0.3≤WS/TG≤0.6 is satisfied; and
for each of the internal electrode layers, a dimension in the width direction is defined as a dimension WI, and T0<WI is satisfied.

2. The multilayer ceramic capacitor according to claim 1, wherein
a dimension of each of the dielectric layers in the lamination direction is defined as a dimension TD, and the dimension TD is about 0.67 μm or greater and about 0.73 μm or less; and
the dielectric layers each include a plurality of grains, and an average value GN of numbers of the grains arranged in the lamination direction in the dielectric layers is 3 or more and 4 or less.

3. The multilayer ceramic capacitor according to claim 1, wherein
a dimension of each of the dielectric layers in the lamination direction is defined as a dimension TD, and the dimension TD is about 0.85 μm or greater and about 0.91 μm or less; and
the dielectric layers each include a plurality of grains, an average value GN of numbers of the grains arranged in the lamination direction in the dielectric layers is 4 or more and 5 or less.

4. The multilayer ceramic capacitor according to claim 1, wherein
the dimension L0 in the length direction is about 1.15 μm or greater and about 1.25 μm or less;
the dimension W0 in the width direction is about 0.65 μm or greater and about 0.75 μm or less;
the dimension T0 in the lamination direction is about 0.55 μm or greater and about 0.65 μm or less;
the dimension WS of each of the side gap portions in the width direction is about 15 μm or greater and about 20 μm or less; and
the dimension TG of each outer layer portion in the lamination direction is about 36 μm or greater and about 43 μm or less.

5. The multilayer ceramic capacitor according to claim 1, wherein
the dielectric layers each include a plurality of grains;
each of the grains has a core-shell structure including a core and a shell surrounding the core; and
for each of the grains, a molar ratio of Ba in the core to Ti included in the grain is higher than a molar ratio of Ba in the shell to the Ti included in the grain.

6. The multilayer ceramic capacitor according to claim 1, wherein the multilayer ceramic capacitor has a substantially rectangular parallelepiped shape.

7. The multilayer ceramic capacitor according to claim 1, wherein a ratio between L0, TO, and W0 is about 2:1:1.2.

8. The multilayer ceramic capacitor according to claim 1, wherein 0.4≤WS/TG≤0.5 is satisfied.

9. The multilayer ceramic capacitor according to claim 2, wherein the dimension TD is about 0.70 μm.

10. The multilayer ceramic capacitor according to claim 9, wherein each of the grains has a grain diameter of about 150 nm or greater and about 200 nm or less.

11. The multilayer ceramic capacitor according to claim 9, wherein a number of the dielectric layers is 405 or more and 430 or less.

12. The multilayer ceramic capacitor according to claim 2, wherein the dimension TD is about 0.88 μm.

13. The multilayer ceramic capacitor according to claim 12, wherein each of the grains has a grain diameter of about 150 nm or greater and about 200 nm or less.

14. The multilayer ceramic capacitor according to claim 12, wherein a number of the dielectric layers is 350 or more and 375 or less.

15. The multilayer ceramic capacitor according to claim 1, wherein a thickness of each of the dielectric layers is about 0.85 μm or greater and about 0.91 μm or less.

16. The multilayer ceramic capacitor according to claim 1, wherein a grain diameter of each of the grains in the dielectric layers of the multilayer chip is larger than a grain diameter of each of the grains in the dielectric layers included in the side gap portions.

17. The multilayer ceramic capacitor according to claim 1, wherein a thickness of each of the internal electrode layers is about 0.49 μm or greater and about 0.55 μm or less.

18. The multilayer ceramic capacitor according to claim 1, wherein each of the internal electrode layers has voids where metal is missing.

19. The multilayer ceramic capacitor according to claim 1, wherein each of the internal electrode layers includes about 85% metal.

20. The multilayer ceramic capacitor according to claim 1, wherein each of the internal electrode layers includes Ni and Sn.
